(19) United States
(12) Patent Application Publication
(10) Pub. No.: US 2003/0026172 A1
(43) Pub. Date: Feb. 6, 2003

(54) Multi-player game clock

(76) Inventor: Charles David Eagle, Austin, TX (US)

Correspondence Address: C. David Eagle, P.O. BOX 495, MIDDLETOWN, MD, 21769, US

(21) Appl. No.: 09/922,256

(22) Filed: Aug. 6, 2001

(51) Int. Cl. G04F 3/00

(52) U.S. Cl. 368/96

(57) ABSTRACT

An apparatus and method for keeping time in a multi-player game is disclosed. The method involves presetting the time remaining for each player, and continuously decrementing a player's timer while the internal clock is associated with that player. A means is provided to end one player's turn and simultaneously begin the next player's turn; thereby changing the association of the internal clock. The list of players is kept ordered as a ring, so that when the last player's turn ends, the first player's turn begins.

### FIELD OF THE INVENTION

The invention relates to a clock for timing multiple activities. More particularly, the present invention relates to a clock for use in timing multiplayer game competitions such as Scrabble.

### BACKGROUND OF THE INVENTION

Competitive multiplayer games wherein players alternate turns are very common and popular worldwide. In many of these games, an advantage can accrue to any player who uses an inordinate amount of time to execute his turns. This advantage is considered unfair, and that unfairness as well as the boredom of waiting for one's turn can significantly reduce the enjoyment of the game. To deal with this, rules have been promulgated limiting the time players may use for their turns. The devices in existence today used to enforce these time limits fall into two broad categories: single turn timers and two player timers. Each of these two timer types has serious deficiencies with respect to multiplayer games. Single turn timers can keep a game moving at a satisfactory pace. However, they do not account for situations where extra time is needed for particularly difficult turns. A player can actually be taking less time, on average, for each turn than the other players, but then be disqualified or lose a turn because he needed more time to deal with an unusual development. Some single turn timers also are flawed by the necessity to wait for the entire time interval to complete before the next player may begin his turn. Other single turn timers can be awkward or cumbersome to reset for the next player, or restrictive in what time limits may be enforced. Also, single turn timers usually do not give any indication of whose turn it is.

Several varieties of two player timers exist. Probably the most advanced are the chess clocks. These clocks address the “difficult turn” problem suffered by single turn timers. Instead of limiting the time taken for a turn, chess clocks attempt to regulate the average time taken for a move.

A typical chess clock includes two clocks and two switches. Each switch starts one clock and stops the other clock simultaneously. Thus, as a player completes a move, he pushes his switch which stops his clock and starts his opponent's clock. In this manner, each player's time taken for the game is measured. The number of moves made is generally recorded separately, using pen and paper.

Clearly, two player timers are not suitable for games with three or more players. In addition, a naive extension of the two player timer solution to N players, wherein each player has his own clock and his own switch, quickly becomes awkward and expensive. A more general solution is needed for multiplayer games.

Curiously, two player timers are also inadequate for timing a single activity consisting of sequential events, such as a manufacturing process. In a factory producing widgets, the manufacturer might like to count each widget completion as an event, and record the accumulated time. The present invention handles this situation easily, simply by setting the number of activities being timed to one.

Three electronic game clocks, all for timing competitive chess, are known.

The first is described in U.S. Pat. No. 4,062,180 (Meshi et al) issued on Dec. 13, 1977. This clock includes a digital display for each player, a digital memory means for storing and counting down each player's time period, switch means for activating the countdown, and add time means for adding unused time from the primary time period to the secondary time period. The second of the electronic chess clocks is disclosed in U.S. Pat. No. 4,472,067 (Richardson et al) issued on Sep. 18, 1984. This clock includes a pair of start switches, a pair of clock means, an LCD display means, reset and advance switches for setting the clock means, and counter means for counting the number of operations of the start switches. The third known chess clock is described in U. S. Pat. No. 4,884,255 (Fischer) issued on Nov. 28, 1989. This apparatus includes a pair of clock means, a pair of start switches for starting and stopping the clock means, and a compensation means for incrementing or decrementing each clock means by a time interval.

All these examples are specific to timing two player games. Accordingly, there is a need in the art for a method of timing multiplayer games and an apparatus capable of performing the new timing method which will increase fairness and maintain the tempo of the games.

### SUMMARY OF THE INVENTION

The present invention relates to a timing device for timing multiple activities. The timing device includes a clock means and a set of timer memory means. At any instant, the clock means is associated with one of the timer memories, causing that timer to increment/decrement synchronously with the clock. The timing device includes a switch, whose actuation causes the clock means to become disassociated from the current timer memory, and immediately reassociated with the next timer memory in the set. The timer memory set is arranged as a ring. The timing device includes a display means coupled to the active timer memory. The preferred embodiment is designed for use as a multiplayer game clock.

In the preferred embodiment, means are provided to set the number of players and to preset each of the timer memories. In this embodiment the timer memories are decremented synchronously with the clock means, and each timer memory represents one player and is decremented during his turn. After setting the number of players N and the timer memories, actuating the switch starts the first player's turn. Thereafter, actuating the switch ends the current player's turn and begins the next player's turn. The players take turns in order, beginning with the first player, then the second, then the third, etc. up to the Nth player. After the Nth player completes his turn, the first player's turn commences and the cycle repeats.

In the preferred embodiment, a player's timer may decrement to zero. When this happens an alarm sounds and the display means flashes the zero time warning. Then, when the switch is actuated, the alarm is turned off, the timer memory of the player whose time has expired is removed from the ring, and it becomes the next player's turn.

In the preferred embodiment, when one game is completed and the user wishes to begin a new game, the timing device may be turned off and then back on, which resets all the memories and allows the number of players to be reentered.

It is the primary object of the present invention to provide a timing device for timing multiple concurrent activities. Although the activities are occurring in parallel, no two activities are ever transpiring simultaneously. Thus, only one actual clock means is required.

It is another object of the present invention to allow a method and apparatus for timing competitive multiplayer games in a manner which prevents any one player from unfairly slowing down the game. This enhances the players' enjoyment of the game.

These and other objects of the present invention will be apparent to one of ordinary skill in the art from the detailed description which follows.

### BRIEF DESCRIPTION OF THE DRAWINGS

FIG. 1 is a functional block diagram of the preferred embodiment of the timing device of the present invention.

### DETAILED DESCRIPTION OF THE PREFERRED EMBODIMENTS

The preferred embodiment of the present invention is described with reference to the timing of competitive Scrabble games. However, it is to be understood that the timing method and apparatus of the present invention can be used in a wide variety of applications.

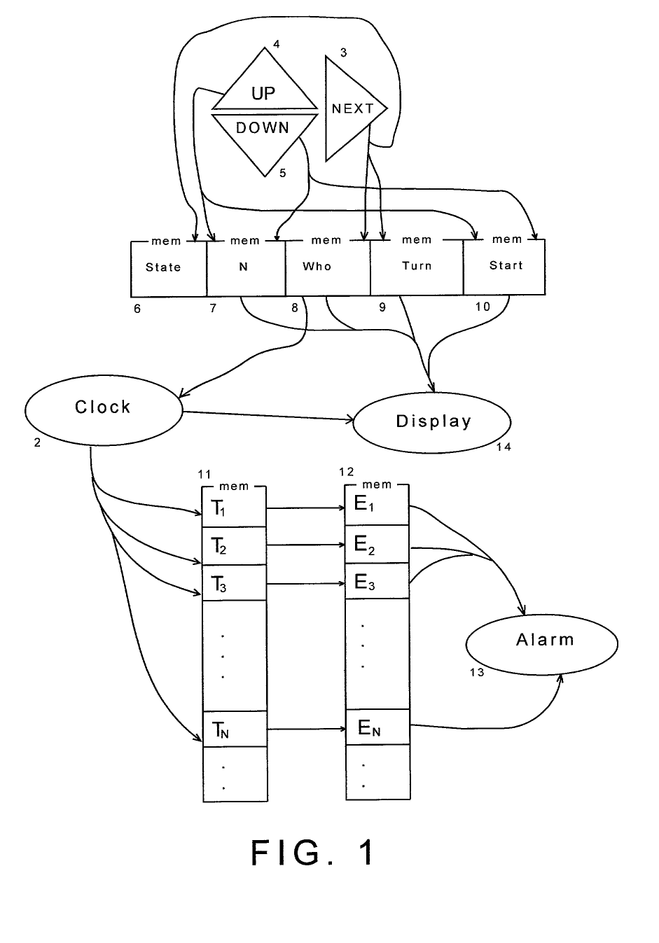

Referring to the FIG. 1, the game clock 1 of the present invention is shown in electrical block diagram form. Button 3 is used by players to indicate that a turn has been completed. Button 3 stops the time running against the player who has completed his turn and starts the time running against the next player. This button is pressure sensitive with a relatively large surface area which can be easily found by the players without looking at game clock 1. Actuation of button 3 also causes alarm 13 to emit a tone to alert players that a turn has ended.

When game clock 1 is turned on it is in setup mode. While in this mode buttons 3, 4 and 5 may be used to set the number of players and the initial time period, overriding the defaults for both those values. Button 4 increments by one the value being modified, button 5 decrements that value by one, and button 3 stores the value being modified and allows the next value to be changed. For purposes of clarity in FIG. 1, an arrow is shown between Clock 2 and Display 14. This is intended to show that, during the play of the game, Display 14 is updated each time Clock 2 increments; the reader should be aware that what actually appears on Display 14 is the contents of the player timer which is associated with Clock 2, not the contents of Clock 2 itself.

Referring again to FIG. 1, what follows is a description of the use of game clock 1, from when it is turned on up to the third turn in the game:

1. Activate game clock 1 by providing power to it. (The on/off switch is not shown in FIG. 1.) This sets State=SetN (in memory location 6), N=3 (memory 7), Start=00:15:00 (memory 10), and causes “# players=3” to appear on Display 14. The “3” is blinking on Display 14.

2. Press Up (button 4). This sets N=4 (memory 7), and causes “# players=4” to appear on Display 14.

3. Press Next (button 3). This sets State=SetHours (memory 6), and causes “Starting time=00:15:00” to appear on Display 14, with the “00” in the hours position blinking.

4. Press Next (button 3). This sets State=SetMins (memory 6), and causes the “00” to stop blinking and the “15” to start blinking.

5. Press Down (button 5). This sets Start=00:14:00 (memory 10), and causes “Starting time=00:14:00” to appear on Display 14, with the “14” in the minutes position blinking.

6. Press Down (button 5). This sets Start=00:13:00 (memory 10), and causes “Starting time=00:13:00” to appear on Display 14, with the “13” in the minutes position blinking.

7. Press Down (button 5). This sets Start=00:12:00 (memory 10), and causes “Starting time=00:12:00” to appear on Display 14, with the “12” in the minutes position blinking.

8. Press Next (button 3). This sets State=SetSecs (memory 6), and causes the “12” to stop blinking and the “00” in the seconds position to start blinking.

9. Press Next (button 3). This sets State=Playing (memory 6), Turn=1 (memory 9) and Who=1 (memory 8). Further, in memory array 11, it sets T₁=00:12:00, T₂=00:12:00, T₃=00:12:00, and T₄=00:12:00. Memory array 11 is used to store the time remaining for each player. In memory array 12, it sets E₁=False, E₂=False, E₃=False, and E₄=False. Memory array 12 is used to store the “time expired” flag for each player. Also, “Player 1 00:12:00” is caused to appear on Display 14. Clock 2 is associated with T₁, which will be decremented until Next (button 3) is pressed. Display 14 is refreshed each time T₁, changes. For purposes of this example, we assume player 1 takes 8 seconds for the first turn.

10. Press Next (button 3). This sets Who=2 (memory 8) and stops the decrementing of T₁. Clock 2 is associated with T₂, which will be decremented until Next (button 3) is pressed. “Player 2 00:12:00” appears on Display 14, which is now updated each time T₂ changes. In this example player 2 takes 9 seconds for the first turn.

11. Press Next (button 3). This sets Who=3 (memory 8) and changes Display 14 to read “Player 3 00:12:00”. T₂ stops decrementing and Clock 2 is associated with T₃. Assume player 3 takes 11 seconds for turn 1.

12. Press Next (button 3). This sets Who=4 (memory 8) and changes Display 14 to read “Player 4 00:12:00”. T₃ stops decrementing and Clock 2 is associated with T₄. Assume player 4 takes 13 seconds for turn 1.

13. Press Next (button 3). This sets Who=1 (memory 8) and Turn=2 (memory 9). T₄ stops decrementing and Clock 2 is associated with T₁. Display 14 reads “Player 1 00:11:52”. Player 1 then takes 8 seconds for the second turn.

14. Press Next (button 3). This sets Who=2 (memory 8), stops the decrementing of T₁, associates Clock 2 with T₂ and causes Display 14 to read “Player 2 00:11:51”. Player 2 takes 9 seconds for the second turn.

15. Press Next (button 3). This sets Who=3 (memory 8), stops the decrementing of T₂, associates Clock 2 with T₃ and causes Display 14 to read “Player 3 00:11:49”. Presume that player 3 is unable to complete the turn, and T₃ runs to zero. When time runs out Alarm 13 sounds, and remains on until Next is pressed.

16. Press Next (button 3). This sets E₃=True (in memory array 12), Who=4, turns off Alarm 13, associates Clock 2 with T₄, and causes “Player 4 00:11:47” to appear on Display 14.

17. Press Next (button 3). This sets Who=1 (memory 8) and Turn=3 (memory 9). T₄ stops decrementing and Clock 2 is associated with T₁. Display 14 reads “Player 1 00:11:44”. Player 1 then takes 8 seconds for the third turn.

18. Press Next (button 3). This sets Who=2 (memory 8), stops the decrementing of T₁, associates Clock 2 with T₂ and causes Display 14 to read “Player 2 00:11:42”. Player 2 takes 9 seconds for the third turn.

19. Press Next (button 3). This sets Who=4 (memory 8), stops the decrementing of T₂, associates Clock 2 with T₄ and causes Display 14 to read “Player 4 00:11:34”. Player 4 takes 13 seconds for the third turn.

What is claimed is:

1. A device for timing multiple activities which comprises:
a clock means; multiple timer memories (one for each activity); a means to couple said clock means to a specific timer memory, causing said timer to be either incremented or decremented in synchronization with said clock; a switch to uncouple said clock means from one timer memory and simultaneously couple said clock means to the next timer memory; and a display means coupled to the coupled timer memory for displaying the time used by or remaining to that activity.

2. A timing device as claimed in claim 1 wherein a means is provided to set the number of activities being timed.

3. A timing device as claimed in claim 2 wherein said timer memories include means for presetting said memories to a certain initial time.

4. A timing device as claimed in claim 3 further comprising alarm means coupled to said timer memory to indicate when a timer reaches zero.

5. A timing device as claimed in claim 4, configured to be used as a multiplayer game clock; wherein each timer memory corresponds to one player (or team) in the game; and where players take turns in a prescribed order, and where the players' turns are linked in a ring so that immediately upon completion of the last player's turn the first player's turn commences; and where players whose timers have reached zero are removed from said player ring.

6. A timing device as claimed in claim 5 further comprising a means to count the number of turns played; and also comprising a means to set the number of turns that must be completed before the timer reaches zero; and also comprising an automatic means of resetting all the timers to the initial time after the required number of turns have been completed.
